(19) United States
(12) Patent Application Publication
(10) Pub. No.: US 2004/0266292 A1
(43) Pub. Date: Dec. 30, 2004

(54) Fibre mat, moulded piece produced therefrom and method for production thereof

(76) Inventors: Jochen Gassan, Eschwege (DE); Ansgar Engel, Marienmunster (DE)

Correspondence Address: Kaplan & Gilman, 900 Route 9 North, Woodbridge, NJ, 07095, US

(21) Appl. No.: 10/492,579

(22) PCT Filed: Oct. 17, 2002
(86) PCT No.: PCT/EP02/11653

(30) Foreign Application Priority Data
Oct. 17, 2001 (DE) 101 51 368.2

(51) Int. Cl. B29C 31/00

(52) U.S. Cl. 442/59; 264/322; 264/324

(57) ABSTRACT

A fibre mat as intermediate in the production of moulded pieces with preferably the same wall thickness is disclosed, comprising fibres made overwhelmingly of cellulose which are pressed together with a plastic in a homogeneous mixture. The plastic is in the form of fire with a length in the range of 30-100 mm and the cellulose fibres have a length of 10-100 mm. The cellulose fibres preferably comprise natural fibres, formed from, flax, sisal, hemp, kenaf, technical viscose fibres or mixtures thereof, or from regenerated cellulose, particularly synthetic cellulose obtained from wood.

The invention relates to a fibre mat according to the preamble of claim 1, a moulded piece produced from this fibre mat and a method for production thereof.

A method is already known from DE 2845117 A1 for producing sheets made of cellulose-containing material and at least one thermoplastic binder, which can be compressed into moulded pieces, in which the cellulose-containing material and the thermoplastic binders are mixed and the mixture is formed into sheets in the heated state. In order to produce sheets economically which are distinguished by good homogeneity and mechanical properties and also which can be finish-pressed in a simple manner into moulded pieces of high quality, the cellulose-containing material is shredded into fibrous material and mixed with the thermoplastic binders, a fleece is formed from the mixture and the fleece is compressed into sheets by the effect of heat and pressure. There can be used as cellulose-containing material, waste from cellulose materials, such as paper, cardboard, textiles etc. but also in addition however, possibly even in a predominant proportion, peat, bark and in a particularly preferred manner dried plant parts from annual plants, such as straw or the like. In one embodiment, cellulose-containing material, such as paper and cardboard waste, is comminuted into particles with dimensions of approximately 5×5 mm and is then shredded so that the maximum fibre length is approximately 5 mm. A dry powder of fibre-like particle nature made of polyethylene is used as thermoplastic binder. With respect to these particles, no length data are given. The moulded pieces produced from these sheets do however have a limited strength so that they normally also contain duroplastic binders.

It is also known to use glass fibres for reinforcing moulded pieces, which glass fibres have a length of more than 10 mm. These moulded pieces are however relatively brittle and susceptible to cracking particularly at low temperatures.

It is therefore the object of the present invention to produce a fibre mat as intermediate product in the production of moulded pieces preferably of the same wall thickness, made of fibres, which are compressed with plastic material in a homogeneous mixture and comprise predominantly cellulose, from which a strong, extensively impact-resistant, light, low-emission and low-odour and also recyclable moulded piece can be produced. It is also the object of the present invention to produce a moulded piece of this type and to indicate a method for the production thereof.

This object is achieved according to the invention by a fibre mat having the features of claim 1. Advantageous developments are revealed in the sub-claims.

As a result of the fact that the plastic material is in the form of fibres with a length in the range of 30-100 mm and the cellulose fibres have a length of 10-100 mm, a relatively dimensionally stable fibre mat can be obtained in particular after needling, which can be handled in a problem-free manner until being further processed. The moulded piece compressed therefrom retains, due to the large length of the cellulose fibres, high strength and impact resistance, in particular at very low temperatures. As a result of the fact that no duroplastic binders are required, the moulded pieces can be produced economically, have a low weight and are extensively emission-free and odour-free and also easily recyclable. Those cellulose fibres are preferred which have a length in the range of 50-100 mm and, in particular those, the average length of which is 70 mm+/−20%. Their proportion of the total weight of the fibre mat can be between 10 and 90%.

The cellulose fibres advantageously comprise natural fibres from annual plants, such as hemp, flax, sisal or kenaf or technical viscose fibres, and also from regenerated cellulose, i.e. synthetic cellulose which is obtained preferably from wood but does not contain its lignin components. Also mixtures of the above-mentioned different cellulose fibres are usable.

The cellulose fibres can have been pre-treated, before formation of the fibre mat, in the known manner, chemically, chemico-physically or physically, e.g. bleached, mercerised, alkalised, acetylated or provided with an adhesive, a flameproofing agent or hydrophobing agents.

Preferably polypropylene is used for the plastic material fibres. However, in general as textile fibres, tape fibres or fibre-shaped film cuttings, they comprise polyolefins, technical plastic materials and/or copolymers and also mixtures of a plurality of polymers, (e.g. as bico fibres). In order to obtain a homogeneous fibre mixture, the plastic material fibres should have a fineness in the range of 3.3-25 dtex.

During the mat production, in addition to the cellulose fibres and the plastic material fibres, also auxiliary agents, in particular processing aids, such as antistatic agents or adhesives but also hydrophobing agents, flameproofing agents and softeners can be added. The total quantity thereof should however not exceed 10% of the total weight of the mat.

In order to improve the needling properties of the mat, for minimising possible odour emissions of the finished moulded piece, which are caused by the natural fibres, and also for defined compensation of distortion, the fibre mat can be covered at least on one side with a light fleece made of e.g. polypropylene/polyester and with a basis weight up to 300 g/m². The bond between fibre mat and light fleece is effected expediently by needling.

The production of the fibre mat takes place fundamentally in the known manner, as is known for example from DE 2845117 A1. The essential steps of mat formation are the following:

Thus, in a processing plant, the corresponding fibre components are delivered in bale form and supplied, via a bale opener with metering devices, pre-opener, fine-opener, fibre finisher, mixing chamber and hopper store, as fibre mixture to the fleece plant. The cellulose and plastic material fibres are released from the respective bales by the bale opener. A weighing device meters the respectively desired mixing ratio of the fibres on a collecting belt.

From the collecting belt, the material is conveyed to a mixing opener (pre-opener) in which the fibre components are mixed roughly.

The subsequent fine-opener serves for shortening, refining and cleaning the bast fibres. This device is provided with a trough feed and a saw-tooth drum. By means of expanded metal gratings disposed on the circumference of the drum, separation of shives and other impurities is effected.

In the fibre finisher, the fibres are treated by a plant for spraying with liquid additives, such as hydrophobing agents, lubricants, flameproofing agents, antistatic agents, adhesives and the like.

In the subsequent mixing hopper (mixing chamber), the fibre mixture is homogenised and stored temporarily. A stationary rotary separator in the hopper ceiling ensures uniform layering of the fibres and the formation of a fibre sandwich. This fibre sandwich is vertically cut by a discharge cutter.

The hopper feeder finally meters the fibre mixture via a steep lattice belt into a volumetric feeder chute. This meters the fibre cake via metering scales into the fleece plant.

The fleece plant comprises a pre-fleece former and an end fleece former. In the pre-fleece former, a pre-fleece is produced either by a carding system or by an aerodynamic system. The fibres are hereby deposited with an orientation.

In the end fleece former, the homogeneously pre-mixed fibre components in the form of the pre-fleece are disintegrated by a high-speed saw-tooth drum into individual fibres. Because of the centrifugal force, the fibres are detached from the drum and are blown onto the screen face by the air stream of a cross-flow fan. By means of simultaneous suction by low pressure ventilators, the randomly distributed fleece formation is effected on the screen face. By corresponding adjustment of the material withdrawal speed, desired basis weights for the fibre mats can be obtained.

The subsequent needling of the fibre mats is a mechanical bonding which is based on intertwining of the fibres and on increasing the friction of the fibres relative to each other, which is caused by the compression of the fleece. The fleece is initially pre-compressed by rollers or a pressure belt and then supplied to the needle machine.

The endlessly produced needle fleece is cut to size finally by a transverse cutting and longitudinal cutting device to mat proportions for pallet stacking or for rolls. The mats are deposited on pallets via an automatic stacking device. In the case of rolls, the needle fleece is wound up on carrier tubes.

The production of moulded pieces can be effected separately from the fibre mat production spatially and temporally. The possibility exists thereby of producing the moulded piece together with a lamination of a fabric, a decorative film or the like in the so-called one-shot method. As a result, the production costs can be reduced considerably.

For this purpose, the fibre mat is initially supplied to a pre-heating station in which it is heated to approximately 180 degrees Celsius. At the same time, a pre-compression takes place. At this temperature, the plastic material fibres melt so that they lose their fibre structure. Subsequently, the heated fibre mat together with the lamination is introduced into a moulding press in which the moulded piece obtains its shape and simultaneously the lamination is bonded to the moulded piece by the melted plastic material. The moulding press has a temperature of less than 80 degrees Celsius so that the moulded piece is cooled and the melted plastic material is bonded, as a result of which a dimensionally stable moulded piece can be removed from the moulding press.

A moulded piece of this type, which has been produced up to 50% by weight from cellulose fibres and 50% by weight from polypropylene fibres, has for example a density of 1.0 g/cm³, a water absorption of 4.5% by weight, a bending modulus of elasticity of 3500 N/mm² and a bending resistance of 65-70 N/mm².

1. A fiber mat for use as an intermediate product in the production of moulded pieces of substantially the same wall thickness, comprising: fibers, which are compressed with plastic material in a homogeneous mixture and comprise predominantly cellulose fibers, wherein the plastic material is in the form of fibers with a length in the range of about 30-100 mm and the cellulose fibers have a length of about 10-100 mm.

2. The fiber mat according to claim 1, wherein the cellulose fibers comprise natural fibers of hemp, flax, sisal, kenaf, technical viscose fibers or mixtures thereof.

3. The fiber mat according to claim 1, wherein the cellulose fibers comprise regenerated cellulose fibers.

4. The fiber mat according to claim 1, wherein the cellulose fibers have a length in the range of about 50-100 mm.

5. The fiber mat according to claim 4, wherein an average length of the cellulose fibers is about 70 mm+/−20%.

6. The fiber mat according to claim 1, wherein a proportion of cellulose fibers in a total weight of the fiber mat is between about 10 and 90%.

7. The fiber mat according to claim 1, wherein the cellulose fibers are pre-treated chemically, thermally or chemico-physically.

8. The fiber mat according to claim 1, wherein the plastic material fibers comprise polypropylene.

9. The fiber mat according to claim 1, wherein the plastic material fibers have a fineness of 3.3-25 dtex and any cross-sectional shape.

10. The fiber mat according to claim 1, wherein the mat is bonded by needling the fibers.

11. The fiber mat according to claim 1, further comprising hydrophobing agents, softeners, flameproofing agents and/or adhesives.

12. The fiber mat according to claim 1, further comprising a needled fiber top layer on at least one side of the mat that is made of polypropylene/polyester with a basis weight up to about 300 g/m².

13. A moulded piece produced from a fiber mat, the fiber mat comprising: fibers, which are compressed with plastic material in a homogeneous mixture and comprise predominantly cellulose fibers, wherein the plastic material is in the form of fibers with a length in the range of about 30-100 mm, the cellulose fibers have a length of about 10-100 mm, and said moulded piece contains uniformly distributed natural fibers with a length in a range of about 10-100 mm in a homogeneous plastic material layer.

14. The moulded piece according to claim 13, wherein the piece has a density of approximately 0.9 g/cm³.

15. The moulded piece according to claim 13, wherein the piece has a water absorption in the range of about 4-6% by weight.

16. The moulded piece according to claim 13, further comprising a decorative layer bonded directly to the compressed fiber mat.

17. A method of producing a moulded piece, comprising:
forming a fiber mat comprising fibers, which are compressed with plastic material in a homogeneous mixture and comprise predominantly cellulose fibers wherein the plastic material is in the form of fibers with a length in the range of about 30-100 mm and the cellulose fibers have a length of about 10-100 mm.; and
heating the fiber mat before compressing to a temperature of approximately 180-200 degrees Celsius.

18. The method according to claim 17, wherein a pre-compression is implemented during heating.

19. The method according to claim 17, wherein at the same time as compression of the fiber mat, a decorative layer is applied onto the mat using a one-shot method.

20. The method according to claim 17, wherein a form tool has a temperature of less than about 80 degrees Celsius during compression.

21. The moulded piece according to claim 13, wherein the cellulose fibers comprise natural fibers of hemp, flax, sisal, kenaf, technical viscose fibers or mixtures thereof.

22. The moulded piece according to claim 13, wherein the cellulose fibers comprise regenerated cellulose fibers.

23. The moulded piece according to claim 13, wherein the cellulose fibers have a length in the range of about 50-100 mm.

24. The moulded piece according to claim 23, wherein an average length of the cellulose fibers is about 70 mm+/−20%.

25. The moulded piece according to claim 13, wherein a proportion of cellulose fibers in a total weight of the fiber mat is between about 10 and 90%.

26. The moulded piece according to claim 13, wherein the cellulose fibers are pre-treated chemically, thermally or chemico-physically.

27. The moulded piece according to claim 13, wherein the plastic material fibers comprise polypropylene.

28. The moulded piece according to claim 13, wherein the plastic material fibers have a fineness of 3.3-25 dtex and any cross-sectional shape.

29. The moulded piece according to claim 13, wherein the mat is bonded by needling the fibers.

30. The moulded piece according to claim 13, further comprising hydrophobing agents, softeners, flameproofing agents and/or adhesives.

31. The moulded piece according to claim 13, further comprising a needled fiber top layer on at least one side of the mat that is made of polypropylene/polyester with a basis weight up to about 300 g/m².
